(19) United States
(12) Patent Application Publication
(10) Pub. No.: US 2022/0261861 A1
(43) Pub. Date: Aug. 18, 2022

(54) VEHICLE SALES MANAGEMENT APPARATUS, VEHICLE SALES MANAGEMENT SYSTEM AND VEHICLE SALES MANAGEMENT METHOD

(71) Applicant: Honda Motor Co., Ltd., Tokyo (JP)

(72) Inventor: Shoichiro Suzuki, Minato-ku, Tokyo (JP)

(21) Appl. No.: 17/617,478

(22) PCT Filed: May 21, 2020
(86) PCT No.: PCT/JP2020/020030

§ 371 Date: Dec. 8, 2021

(30) Foreign Application Priority Data
Jun. 12, 2019 (JP) 2019-109250

(51) Int. Cl. G06Q 30/02; G06Q 30/08

(52) U.S. Cl. CPC G06Q 30/0278; G06Q 30/08

(57) ABSTRACT

A vehicle sales management apparatus that manages a trade-in vehicle traded in at a first store and owned by the first store such that the trade-in vehicle can be sold at a second store different from the first store. The vehicle sales management apparatus includes a CPU and a memory. The CPU is configured to perform acquiring a trade-in price and a sales price of the trade-in vehicle, deciding a purchase price when the second store purchases the trade-in vehicle from the first store on the basis of the trade-in price and the sales price acquired in the acquiring, and transmitting the purchase price decided in the deciding and the sales price acquired in the acquiring to the second store.

### CROSS-REFERENCE TO RELATED APPLICATION

This application is a National Stage of PCT international application Ser. No. PCT/JP2020/020030 filed on May 21, 2020 which designates the United States, incorporated herein by reference, and which is based upon and claims the benefit of priority from Japanese Patent Application No. 2019-109250, filed on Jun. 12, 2019, the entire contents of which are incorporated herein by reference.

### TECHNICAL FIELD

This invention relates to a vehicle sales management apparatus, a vehicle sales management system and a vehicle sales management method configured to manage sale of a trade-in vehicle and others.

### BACKGROUND ART

As this type of apparatus, there has been conventionally known an apparatus that enables a used car traded in by an automobile store to be put up for an automobile auction by a simple user interface operation (see Patent Literature 1). With the apparatus described in Patent Literature 1, a trade-in vehicle can be easily put up for an automobile auction, and a period during which the trade-in vehicle is owned as a stock at an automobile store can be shortened.

On the other hand, in an automobile store that sells a new car, a user who newly purchases a vehicle may trade-in a currently owned vehicle. In this case, in order to increase the user's satisfaction level, it is desirable to purchase the trade-in vehicle as expensive as possible.

### CITATION LIST

### Patent Literature

Patent Literature 1: Japanese Unexamined Patent Publication No. 2004-94643

### DISCLOSURE OF INVENTION

### Problems to be Solved by the Invention

However, when the vehicle is traded in at a high price, the sales price of the trade-in vehicle increases, and the period during which the trade-in vehicle is owned by the own shop becomes longer, leading to an increase in cost. Therefore, it is difficult to present an expensive trade-in price for the trade-in vehicle, and it is difficult to sufficiently increase the user's satisfaction level.

### Means for Solving Problem

An aspect of the present invention is a vehicle sales management apparatus managing a trade-in vehicle traded in at a first store and owned by the first store such that the trade-in vehicle can be sold at a second store different from the first store, the vehicle sales management apparatus includes a CPU and a memory. The CPU is configured to perform acquiring a trade-in price and a sales price of the trade-in vehicle, deciding a purchase price when the second store purchases the trade-in vehicle from the first store on the basis of the trade-in price and the sales price acquired in the acquiring, and transmitting the purchase price decided in the deciding and the sales price acquired in the acquiring to the second store.

Another aspect of the present invention is a vehicle sales management system that includes the vehicle sales management apparatus, a first store terminal managed by the first store and capable of communicating with the vehicle sales management apparatus, and a second store terminal managed by the second store and capable of communicating with the vehicle sales management apparatus. The CPU is configured to perform the transmitting including, on the basis of the transmission request from the second store terminal, transmitting, to the second store terminal, the purchase price at the time when the second store purchases, from the first store, the trade-in vehicle purchased by the first store and owned by the first store, and the sales price of the trade-in vehicle.

Further another aspect of the present invention is a vehicle sales management method managing a trade-in vehicle traded in at a first store and owned by the first store such that the trade-in vehicle can be sold at a second store different from the first store, the vehicle sales management method includes acquiring a trade-in price and a sales price of the trade-in vehicle, deciding a purchase price when the second store purchases the trade-in vehicle from the first store on the basis of the trade-in price and the sales price acquired in the acquiring, and transmitting the purchase price decided in the deciding and the sales price acquired in the acquiring to the second store.

### Effect of the Invention

According to the present invention, it is possible to actively present an expensive trade-in price for the trade-in vehicle, and it is possible to sufficiently increase the user's satisfaction level.

### BRIEF DESCRIPTION OF THE DRAWINGS

FIG. 1 is a diagram illustrating a schematic configuration of a vehicle sales management system including a vehicle sales management apparatus according to an embodiment of the present invention;

FIG. 2 is a block diagram illustrating a configuration of a main part of a vehicle sales management system 100 using a vehicle sales management apparatus according to an embodiment of the present invention;

FIG. 3 is a block diagram illustrating a configuration of a main part of the server apparatus of FIG. 2;

FIG. 4 is a diagram for describing a relationship between trade-in price, purchase price, and sales price;

FIG. 5 is a flowchart illustrating an example of purchase price decision processing executed by the server apparatus of FIG. 2;

FIG. 6A is a flowchart illustrating an example of shared used car sales processing executed by the server apparatus of FIG. 2; and

FIG. 6B is a flowchart illustrating an example of revised purchase price decision processing.

### DESCRIPTION OF EMBODIMENT

A vehicle sales management apparatus according to an embodiment of the present invention constitutes a part of a vehicle sales management system that provides a sales management service of a vehicle traded in by an automobile store (referred to as a trade-in vehicle sales management service).

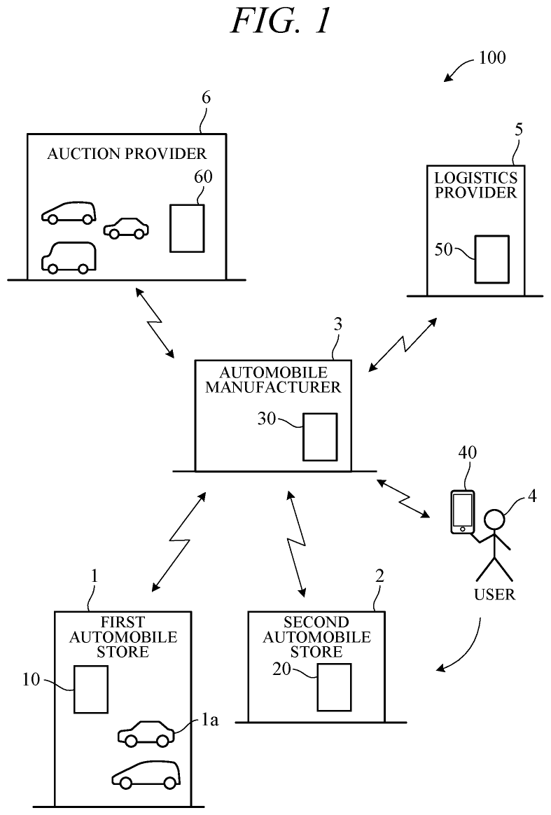

FIG. 1 is a diagram illustrating a schematic configuration of a vehicle sales management system including a vehicle sales management apparatus according to an embodiment of the present invention. As illustrated in FIG. 1, a vehicle sales management system 100 according to the present embodiment includes a first store terminal 10 included in a first store 1, a second store terminal 20 included in a second store 2, and a server apparatus 30 included in a business entity 3 that provides a trade-in vehicle sales management service. The vehicle sales management apparatus according to the present embodiment mainly includes the server apparatus 30.

The business entity 3 is an automobile manufacturer that manufactures and sells automobiles, an associated company that sells and manages used cars of vehicles manufactured by the automobile manufacturer, and the like.

The first and second stores 1 and 2 are automobile stores that use the trade-in vehicle sales management service provided by the business entity 3. The first and second stores 1 and 2 are stores (dealers) that retail new cars or used cars manufactured and sold by specific automobile manufacturers, stores (sub-dealers) that retail new cars or used cars manufactured and sold by unspecified automobile manufacturers, and the like.

Note that the first and second stores 1 and 2 may exist in different regions, may be dealers operated by different companies, or one may be a dealer and the other may be a sub-dealer. That is, the first and second stores 1 and 2 may be automobile stores of different affiliated companies or of different regions.

The first store 1 owns a plurality of vehicles including a vehicle 1a as stock vehicles. The vehicle 1a is a trade-in vehicle traded in by the first store 1 and owned by the first store 1. The first store 1 manages it as a shared used car using the trade-in vehicle sales management service. Here, the shared used car is a vehicle managed so that a vehicle traded in by one automobile store and owned by the one automobile store can also be sold by another automobile store different from the one automobile store. The shared used car is owned by the one automobile store that has purchased the vehicle until it is purchased by a user. In addition, as will be described below, in the trade-in vehicle sales management service, information regarding the shared used car is managed so as to be shared by a first automobile store and a second automobile store on a communication network such as a wireless communication network, an Internet network, and a telephone communication line network.

In response to a request from a user 4 who wants to purchase the vehicle, the second store 2 purchases the shared used car (trade-in vehicle 1a) owned by the first store 1 and sells it to the user 4. At this time, the second store 2 negotiates with the user 4 without laying in the trade-in vehicle 1a from the first store 1. As described above, the shared used car is owned by the automobile store that has acquired the vehicle until it is purchased by a user.

Note that, in FIG. 1, for the sake of convenience, two automobile stores: the first store 1 and the second store 2 are illustrated, but any number of automobile stores may be included in the vehicle sales management system. That is, the number of automobile stores that use the trade-in vehicle sales management service is not limited to two.

The vehicle sales management system 100 further includes a user terminal 40 owned by the user 4 who wants to purchase the trade-in vehicle 1a, a logistics provider terminal 50 owned by a logistics provider 5 that performs land transportation of the vehicle, and an auction provider terminal 60 owned by an auction provider 6 that operates and manages automobile auctions.

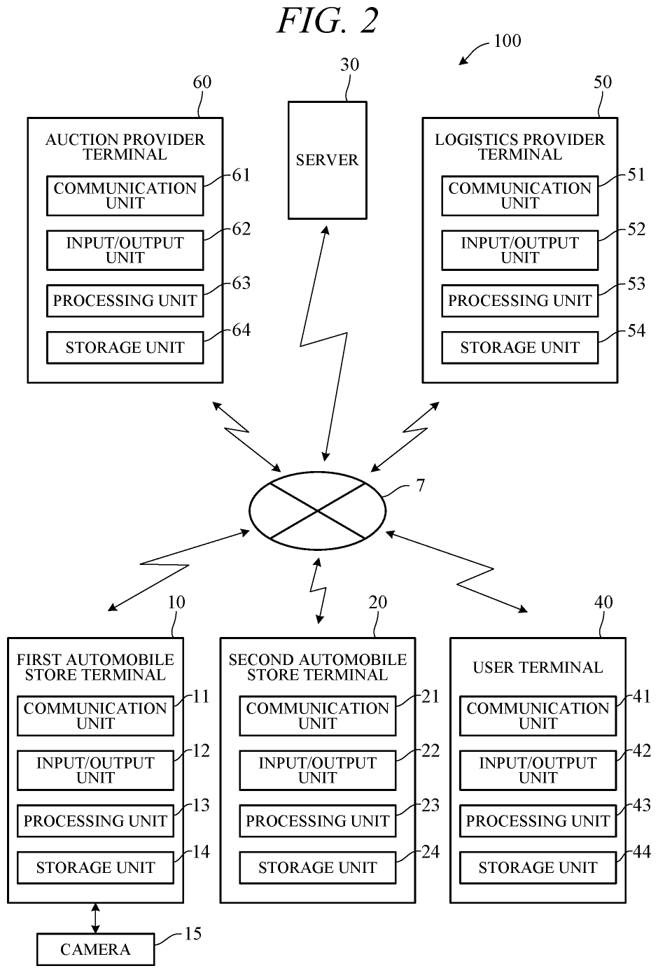

FIG. 2 is a block diagram illustrating a configuration of a main part of the vehicle sales management system 100 using the vehicle sales management apparatus according to the embodiment of the present invention. As illustrated in FIG. 2, the first store terminal 10, the second store terminal 20, the server apparatus 30, the user terminal 40, the logistics provider terminal 50, and the auction provider terminal 60 are connected to a communication network 7 such as a wireless communication network, an Internet network, or a telephone communication line. The first store terminal 10, the second store terminal 20, the server apparatus 30, the user terminal 40, the logistics provider terminal 50, and the auction provider terminal 60 can communicate with each other via the communication network 7.

The first store terminal 10 includes a wireless communication terminal represented by a personal computer, a tablet terminal, or the like operated by an employee, a customer, or the like of the first store 1. As illustrated in FIG. 2, the first store terminal 10 includes a communication unit 11, an input/output unit 12, a calculation unit 13, and a storage unit 14. A camera 15 having an image sensor such as a CCD or a CMOS is connected to the first store terminal 10.

The camera 15 is a camera having an image sensor such as a CCD or a CMOS, is installed outside the first store terminal 10, and is used for capturing an image of the trade-in vehicle 1a or the like. The camera 15 transmits image data obtained by capturing an image of the trade-in vehicle 1a or the like to the first store terminal 10 by wired communication or wireless communication.

The communication unit 11 is configured to be capable of wireless communication with the server apparatus 30 or the like via the communication network 7. In addition, the communication unit 11 is configured to be capable of wired communication or wireless communication with the camera 15. The communication unit 11 transmits, to the server apparatus 30, information including the trade-in price, the sales price, vehicle information, and the like of the trade-in vehicle 1a traded in at the first store 1, together with a store ID for identifying the first store 1. In addition, the communication unit 11 receives, from the server apparatus 30, a command for requesting additional image data with respect to the trade-in vehicle 1a, and transmits the corresponding image data captured by the camera 15 to the server apparatus 30. Furthermore, the communication unit 11 receives, from the server apparatus 30, a command for requesting purchase of the trade-in vehicle 1a from the second store 2.

The input/output unit 12 is a general term for apparatuses that input and output various commands and various information, and includes a keyboard, a mouse, a monitor, a touch panel, and the like. The input/output unit 12 receives a use registration operation of the trade-in vehicle sales management service. Specifically, the input/output unit 12 receives an input operation of store information of the first store 1. The store information includes information necessary for use of the trade-in vehicle sales management service, such as an address, a trade name, and a telephone number of the store. The store information input via the input/output unit 12 is transmitted to the server apparatus 30 via the communication unit 11, and is registered in a database (store database 342 described below) of the server apparatus 30. Thus, the first store 1 can use the trade-in vehicle sales management service.

In addition, the input/output unit 12 receives a registration operation of the trade-in vehicle 1a in the trade-in vehicle sales management service. Specifically, the input/output unit 12 receives an input operation of the trade-in price, the sales price, the vehicle information, and the like of the trade-in vehicle 1a. At this time, the store ID is input to the input/output unit 12 together with the trade-in price, the sales price, the vehicle information, and the like of the trade-in vehicle 1a. The information including the trade-in price, the sales price, the vehicle information, and the like input via the input/output unit 12 is transmitted to the server apparatus 30 via the communication unit 11 together with the store ID, and is registered in a database (vehicle database 341 described below) of the server apparatus 30. Thus, the first store 1 can manage the trade-in vehicle 1a as a shared used car. The sales price is a planned sales price of the trade-in vehicle 1a. Note that when the trade-in vehicle 1a is already on sale at the shop front of the first store 1, the sales price is the price of the trade-in vehicle 1a sold at the shop front. The vehicle information includes image data indicating an image of the interior and the exterior of the vehicle and the like in addition to basic information such as a vehicle type, a model year, a displacement, an engine type, a travel distance, a color, and the presence or absence of a repair history. The image data includes the image data stored in the storage unit 14.

The storage unit 14 includes a volatile or nonvolatile memory, which is not illustrated. The storage unit 14 stores various programs executed by the calculation unit 13, various data, and the like. In addition, the storage unit 14 stores the image data received from the camera 15 via the communication unit 11.

The calculation unit 13 includes a CPU, executes predetermined processing on the basis of information (signal) input via the input/output unit 12, information (signal) received from the outside of the first store terminal 10 via the communication unit 11, data stored in the storage unit 14, image data input via the camera 15, and the like, and outputs a control signal to the communication unit 11, the input/output unit 12, and the storage unit 14. Thus, the first store 1 can confirm the vehicle information of the trade-in vehicle 1a, the presence or absence of a negotiation of the trade-in vehicle 1a by another automobile store, and the like via the input/output unit 12.

The second store terminal 20 includes a wireless communication terminal represented by a personal computer, a tablet terminal, or the like operated by an employee, a customer, or the like of the second store 2. As illustrated in FIG. 2, the second store terminal 20 includes a communication unit 21, an input/output unit 22, a calculation unit 23, and a storage unit 24.

The communication unit 21 is configured to be capable of wireless communication with the server apparatus 30 or the like via the communication network 7. The communication unit 21 transmits, to the server apparatus 30, a command for requesting information of the purchase price of the trade-in vehicle 1a owned by the first store 1 together with the store ID for identifying the second store 2, and receives information including the purchase price and the sales price of the trade-in vehicle 1a from the server apparatus 30. In addition, the communication unit 21 transmits information of the desired sales price of the trade-in vehicle 1a to the server apparatus 30 together with the store ID, and receives information of a revised purchase price of the trade-in vehicle 1a from the server apparatus 30. Furthermore, the communication unit 21 transmits a command for requesting additional image data of the trade-in vehicle 1a to the server apparatus 30, and receives the additional image data of the trade-in vehicle 1a from the server apparatus 30.

The input/output unit 22 is a general term for apparatuses that input and output various commands and various information, and includes a keyboard, a mouse, a monitor, a touch panel, and the like. The input/output unit 22 receives a use registration operation of the trade-in vehicle sales management service. Specifically, the input/output unit 22 receives an input operation of store information of the second store 2. The store information input via the input/output unit 22 is transmitted to the server apparatus 30 via the communication unit 21, and is registered in a database (store database 342 described below) of the server apparatus 30. Thus, the second store 2 can use the trade-in vehicle sales management service. The store information includes information necessary for use of the trade-in vehicle sales management service, such as an address, a trade name, and a telephone number of the store, or the like. Thus, the second store 2 can use the trade-in vehicle sales management service.

In addition, the input/output unit 22 receives a transmission request operation of the price information of the shared used car. Specifically, the input/output unit 22 receives an input operation of information that can specify the shared used car, such as a vehicle type, a model year, and a travel distance of the target shared used car, and a store ID. When this input operation is performed, a command for requesting transmission of the price information together with the information input by the input operation is transmitted to the server apparatus 30 via the communication unit 21. Upon receiving the command for requesting transmission of the price information, the server apparatus 30 searches a database (vehicle database 341 described below) for a corresponding shared used car on the basis of information associated with the command, and transmits the price information including the purchase price, the sales price, and the vehicle information of the searched shared used car (here, the trade-in vehicle 1a) to the second store terminal 20. When there is a plurality of searched shared used cars, the price information includes a purchase price, a sales price, and vehicle information of each of the plurality of searched shared used cars.

In addition, the input/output unit 22 displays the price information received from the server apparatus 30 via the communication unit 21. At that time, the input/output unit 22 may display the price information with the purchase price in a non-display state so that the purchase price is not visually recognized by the user 4.

In addition, the input/output unit 22 receives an input operation of the desired sales price. When this input operation is performed, information of the desired sales price is transmitted to the server apparatus 30 via the communication unit 21. In a case where there is a request for price reduction from the user 4 with respect to the sales price of the shared used car, the desired sales price is input according to the request for price reduction by a clerk or the like of the second store 2 during the negotiation with the user 4.

In addition, the input/output unit 22 receives a purchase request operation of the shared used car. The purchase request operation is performed by a clerk or the like of the second store 2 when a negotiation for purchase of the shared used car is concluded with the user 4 at the second store 2. When this operation is performed, a command of purchase request related to the shared used car to be purchased (here, the trade-in vehicle 1a) is transmitted to the server apparatus 30 via the communication unit 21. The command of purchase request is transmitted to an automobile store (here, the first store 1) that owns the shared used car to be purchased via the server apparatus 30.

Furthermore, the input/output unit 22 receives an operation for requesting additional image data. In a case where there is a request for adding new image data of the shared used car from the user 4, the operation for requesting additional image data is performed by a clerk or the like of the second store 2 during a negotiation with the user 4. For example, when the user 4 requests image data obtained by capturing an image of the shared used car from the rear, a clerk of the second store 2 inputs information (“vehicle rear” or the like) that can specify the requested image data to the input/output unit 22. This information is referred to as image-specifying information. When the image-specifying information is input via the input/output unit 22, a command for requesting additional image data together with the image-specifying information is transmitted to the server apparatus 30 via the communication unit 21. Upon receiving the command for requesting additional image data, the server apparatus 30 transmits image data corresponding to the image-specifying information to the second store terminal 20.

The storage unit 24 includes a volatile or nonvolatile memory, which is not illustrated. The storage unit 24 stores various programs executed by the calculation unit 23, various data, and the like.

The calculation unit 23 includes a CPU, executes predetermined processing on the basis of information (signal) input via the input/output unit 22, information (signal) received from the outside of the second store terminal 20 via the communication unit 21, data stored in the storage unit 24, and the like, and outputs a control signal to the communication unit 21, the input/output unit 22, and the storage unit 24. As a result, the second store 2 can confirm the purchase price, the revised purchase price, the vehicle information, and the like of the trade-in vehicle 1a via the input/output unit 22. In addition, the user who wants to purchase the shared used car can search for the shared used car on sale at the second store 2, and the user 4 can have a negotiation with the second store 2 with respect to the shared used car that the user 4 is interested in. Thus, the negotiation is easily concluded, and the number of users who use the second store 2 can be increased.

The server apparatus 30 is provided in a business entity that provides the trade-in vehicle sales management service. Note that the server apparatus 30 can be configured using a virtual server function on a cloud, or can be configured by distributing each function of the server apparatus 30 to an external apparatus or the like. Note that the configuration of a main part of the server apparatus 30 will be described in detail below.

The user terminal 40 includes a portable wireless terminal represented by a personal computer, a smartphone, or the like operated by the user 4. The user terminal 40 includes a communication unit 41, an input/output unit 42, a calculation unit 43, and a storage unit 44.

The communication unit 41 is configured to be capable of wireless communication with the server apparatus 30 or the like via the communication network 7.

The input/output unit 42 is a general term for apparatuses that input and output various commands and various information, and includes a keyboard, a mouse, a monitor, a touch panel, and the like. The input/output unit 42 receives a user registration operation by the user 4. More specifically, the input/output unit 42 receives user information input operation by the user 4. The user information input via the input/output unit 42 is transmitted to the server apparatus 30 via the communication unit 41, and is registered in a database (user database 343 described below) of the server apparatus 30. Thus, the user 4 can use the trade-in vehicle sales management service. The user information includes an address, a name, a telephone number (contact address), usage information of the trade-in vehicle sales management service, and the like, of the user.

In addition, the input/output unit 42 receives a transmission request operation of the sales price of the shared used car. Specifically, the input/output unit 42 receives an input operation of information that can specify the shared used car, such as a vehicle type, a model year, and a travel distance of the shared used car for which transmission of the sales price is requested, and a user ID. When this input operation is performed, a command for requesting transmission of the sales price together with the information input by the input operation is transmitted to the server apparatus 30 via the communication unit 41. Upon receiving the command for requesting the transmission of the sales price, the server apparatus 30 searches a database (vehicle database 341 described below) for a corresponding shared used car on the basis of information associated with the command, and transmits information of the sales price of the searched shared used car together with the vehicle information to the user terminal 40. When there is a plurality of searched shared used cars, the information of the sales price and the vehicle information of each of the plurality of searched shared used cars are transmitted to the user terminal 40.

In addition, the input/output unit 42 displays the information of the sales price and the vehicle information of the shared used car received from the server apparatus 30 via the communication unit 41. The user 4 considers purchase of the shared used car on the basis of the sales price and the vehicle information displayed on the input/output unit 42. Then, the user 4 visits the second store 2, which is the nearest, that uses the trade-in vehicle sales management service and negotiates with the second store 2.

Furthermore, the input/output unit 42 receives an input operation of the desired sales price. This input operation is performed by the user 4 in a case where the user 4 requests a price reduction with respect to the sales price of the shared used car. When this input operation is performed, the information of the desired sales price is transmitted together with the user ID to the server apparatus 30 via the communication unit 41.

The storage unit 44 includes a volatile or nonvolatile memory, which is not illustrated. The storage unit 44 stores various programs executed by the calculation unit 43, various data, and the like.

The calculation unit 43 includes a CPU, executes predetermined processing on the basis of information (signal) input via the input/output unit 42, information (signal) received from the outside of the user terminal 40 via the communication unit 41, data stored in the storage unit 44, and the like, and outputs a control signal to the communication unit 41, the input/output unit 42, and the storage unit 44. Thus, the user 4 can perform registration of use of the trade-in vehicle sales management service, and confirmation of the sales price and the vehicle information of the trade-in vehicle 1a, or the like via the input/output unit 42. In addition, the user 4 who wants to purchase the shared used car can search for the shared used car on sale at home, and the clerk of the second store 2 can have a negotiation with the user 4 who has searched for the shared used car in advance. Therefore, the negotiation proceeds smoothly.

The logistics provider terminal 50 includes a wireless communication terminal represented by a personal computer, a tablet terminal, or the like operated by, for example, the logistics provider 5. The logistics provider 5 is a group company or the like of the business entity 3 that provides the trade-in vehicle sales management service, and handles logistics of the business entity 3. As illustrated in FIG. 2, the logistics provider terminal 50 includes a communication unit 51, an input/output unit 52, a calculation unit 53, and a storage unit 54.

The communication unit 51 is configured to be capable of wireless communication with the server apparatus 30 or the like via the communication network 7. The communication unit 51 receives, from the server apparatus 30, a signal that instructs to perform land transportation of the shared used car. In addition, the communication unit 51 transmits an acknowledgement signal for the command of land transportation to the server apparatus 30 together with a logistics provider ID for identifying the logistics provider 5. Furthermore, when the land transportation of the shared used car is ended, the communication unit 51 transmits a notification signal of the end of the land transportation to the server apparatus 30 together with the logistics provider ID.

The input/output unit 52 is a general term for apparatuses that input and output various commands and various information, and includes a keyboard, a mouse, a monitor, a touch panel, and the like. The logistics provider 5 inputs a transmission command of an acknowledgement signal for the land transportation of the shared used car, a notification signal of the end of the land transportation, and the like via the input/output unit 52.

The storage unit 54 includes a volatile or nonvolatile memory, which is not illustrated. The storage unit 54 stores various programs executed by the calculation unit 53 and various data.

The calculation unit 53 includes a CPU, executes predetermined processing on the basis of a signal input via the input/output unit 52, a signal received from the outside of the logistics provider terminal 50 via the communication unit 51, and data stored in the storage unit 54, and outputs a control signal to the communication unit 51, the input/output unit 52, and the storage unit 54. Thus, the logistics provider 5 can confirm the land transportation command from the business entity 3 that provides the trade-in vehicle sales management service, and the like, via the input/output unit 52.

The auction provider terminal 60 includes a wireless communication terminal represented by a personal computer, a tablet terminal, or the like operated by the auction provider 6 that operates and manages automobile auctions. As illustrated in FIG. 2, the auction provider terminal 60 includes a communication unit 61, an input/output unit 62, a calculation unit 63, and a storage unit 64.

The communication unit 61 is configured to be capable of wireless communication with the server apparatus 30 or the like via the communication network 7. Upon receiving a command for requesting an auction winning bid price (hereinafter, simply referred to as winning bid price) of the same vehicle type as the designated vehicle from the server apparatus 30, the communication unit 61 transmits information including the winning bid price of the same vehicle type as the designated vehicle to the server apparatus 30 together with an auction provider ID for identifying the auction provider 6.

The input/output unit 62 is a general term for apparatuses that input and output various commands and various information, and includes a keyboard, a mouse, a monitor, a touch panel, and the like. The auction provider 6 inputs, via the input/output unit 62, vehicle information of the same vehicle type and substantially the same conditions as those of the trade-in vehicle 1a.

The storage unit 64 includes a volatile or nonvolatile memory, which is not illustrated. The storage unit 64 stores various programs executed by the calculation unit 63 and various data.

The calculation unit 63 includes a CPU, executes predetermined processing on the basis of information (signal) input via the input/output unit 62, information (signal) received from the outside of the auction provider terminal 60 via the communication unit 61, and data stored in the storage unit 64, and outputs a control signal to the communication unit 61, the input/output unit 62, and the storage unit 64. Thus, the auction provider 6 can confirm the vehicle information to be transmitted to the business entity 3 that provides the trade-in vehicle sales management service or the like via the input/output unit 62.

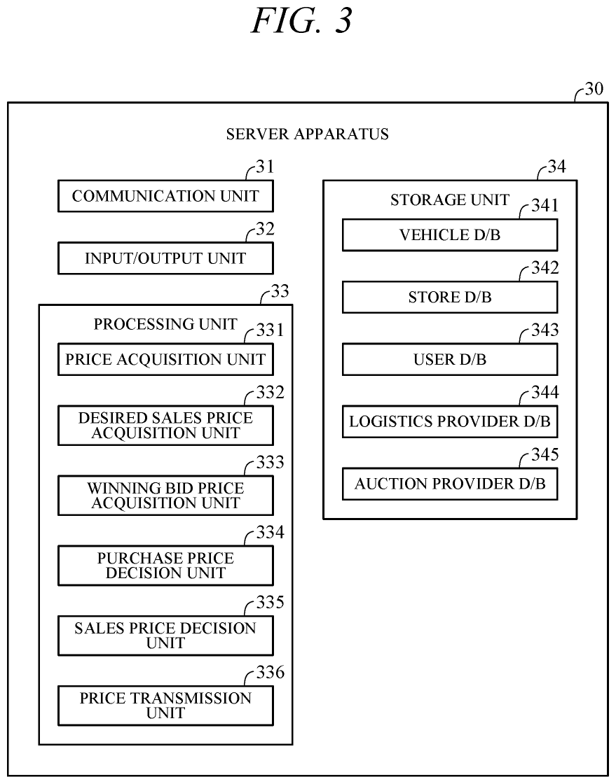

Next, a configuration of a main part of the server apparatus 30 will be described with reference to FIG. 3. FIG. 3 is a block diagram illustrating a configuration of a main part of the server apparatus 30 of FIG. 2. As illustrated in FIG. 3, the server apparatus 30 includes a communication unit 31, an input/output unit 32, a calculation unit 33, and a storage unit 34.

The communication unit 31 is configured to be capable of wireless communication with the first store terminal 10, the second store terminal 20, the user terminal 40, the logistics provider terminal 50, and the auction provider terminal 60 via the communication network 7.

The communication unit 31 receives, from the first store terminal 10, information including the trade-in price and the sales price of the trade-in vehicle 1a together with the store ID. In addition, the communication unit 31 receives a command for requesting transmission of the purchase price or the like of the trade-in vehicle 1a from the second store terminal 20, and transmits information including the purchase price or the like of the trade-in vehicle 1a to the second store terminal 20. Furthermore, the communication unit 31 receives a command for requesting transmission of the sales price of the shared used car including the trade-in vehicle 1a from the user terminal 40, and transmits the corresponding sales price together with the vehicle information to the user terminal 40.

In addition, the communication unit 31 transmits a signal instructing the land transportation of the shared used car to the logistics provider terminal 50, and receives an acknowledgement signal for the land transportation instruction or a notification signal of the end of the land transportation from the logistics provider terminal 50 together with the logistics provider ID. Furthermore, the communication unit 31 transmits a command for requesting the winning bid price of the same vehicle type as the trade-in vehicle 1a to the auction provider terminal 60, and receives information of the corresponding winning bid price together with the auction provider ID from the auction provider terminal 60.

The input/output unit 32 includes, for example, a keyboard, a mouse, a monitor, a touch panel, and the like.

The calculation unit 33 includes a CPU, executes predetermined processing on the basis of a signal input via the input/output unit 32, a signal received from the outside of the server apparatus 30 via the communication unit 31, data stored in the storage unit 34, and outputs a control signal to the communication unit 31, the input/output unit 32, and the storage unit 34. A functional configuration of the calculation unit 33 will be described below.

The storage unit 34 includes a volatile or nonvolatile memory, which is not illustrated. The storage unit 34 stores various programs executed by the calculation unit 33 and various data. The storage unit 34 includes the vehicle database (vehicle D/B) 341, the store database (store D/B) 342, the user database (user D/B) 343, a logistics provider database (logistics provider D/B) 344, and an auction provider database (auction provider D/B) 345 as functional configurations supported by the memory.

The vehicle database 341 stores vehicle information of the shared used car, more specifically, vehicle information indicating a vehicle state and a vehicle characteristic such as a vehicle type, a model year, a vehicle body number, a travel distance, a color, and a maintenance history of the shared used car. When there is a plurality of shared used cars, vehicle information of each of the plurality of shared used cars is stored in the vehicle database 341.

The store database 342 stores store information including the store IDs of the first and second stores 1 and 2 input via the first and second store terminals 10 and 20, and sales history information indicating a history such as a search history and a sales record of the shared used cars of the first and second stores 1 and 2. The sales history information includes trade-in prices, sales prices, purchase prices, winning bid prices, and the like of the shared used cars sold in the past in the first and second store terminals 10 and 20 as a history of sales record.

The user database 343 stores user information including a user ID, an address, a name, a contact address, and the like of the user 4 input via the user terminal 40, and user history information indicating a history of search information, purchase information, and the like by each user. Note that, in a case where there is a plurality of users who uses the trade-in vehicle sales management service, the user database 343 stores user information and user history information of each user.

The logistics provider database 344 stores logistics provider information including a logistics provider ID, an address, a trade name (name), a contact address, a registration date, and the like of the logistics provider 5 registered in advance, and record information indicating a record such as a land transportation history of vehicles by the logistics provider 5. The logistics provider information is stored in advance in the logistics provider database 344 by a registration operation through the input/output unit 52 of the logistics provider terminal 50 by the logistics provider 5. The logistics provider information includes an address, a trade name (name), a contact address, a registration date, and the like of the logistics provider. Note that when the vehicle sales management system 100 includes a plurality of logistics providers, the logistics provider database 344 stores logistics provider information and record information of each logistics provider.

The auction provider database 345 stores auction provider information including the auction provider ID of the auction provider 6 input via the auction provider terminal 60. The auction provider information is stored in advance in the auction provider database 345 by a registration operation through the input/output unit 62 of the auction provider terminal 60 by the auction provider 6. The auction provider information includes, in addition to the auction provider ID, an address, a trade name (name), a contact address, a registration date, and the like of the auction provider. Note that when the vehicle sales management system 100 includes a plurality of auction providers, the auction provider database 345 stores auction provider information of each auction provider.

The calculation unit 33 includes a price acquisition unit 331, a desired sales price acquisition unit 332, a winning bid price acquisition unit 333, a purchase price decision unit 334, a sales price decision unit 335, and a price transmission unit 336 as functional configurations supported by a processor.

The price acquisition unit 331 receives information of the trade-in price of the trade-in vehicle 1a input via the input/output unit 12 of the first store terminal 10 from the first store terminal 10 via the communication unit 31. In addition, the price acquisition unit 331 receives information of the sales price of the trade-in vehicle 1a input via the input/output unit 12 of the first store terminal 10 from the first store terminal 10 via the communication unit 31. In this manner, the price acquisition unit 331 acquires the trade-in price and the sales price of the trade-in vehicle 1a from the first store terminal 10.

The desired sales price acquisition unit 332 receives information of the desired sales price of the trade-in vehicle 1a input via the input/output unit 22 of the second store terminal 20 from the first store terminal 10 via the communication unit 31. In addition, the desired sales price acquisition unit 332 receives information of the desired sales price of the trade-in vehicle 1a input via the input/output unit 42 of the user terminal 40 from the user terminal 40 via the communication unit 31. For example, when receiving a price reduction request from the user 4 during a negotiation with the user 4 at the own shop, the clerk of the second store 2 transmits information of the desired sales price to the server apparatus 30 via the second store terminal 20 in response to the request. In addition, for example, in a case where the user 4 wants a price reduction regarding the trade-in vehicle 1a during a negotiation with the second store 2, the user 4 transmits information of the desired sales price from home or the like to the server apparatus 30 via the user terminal 40.

The winning bid price acquisition unit 333 acquires the winning bid price of a vehicle of the same vehicle type as the trade-in vehicle 1a. More specifically, the winning bid price acquisition unit 333 acquires, from the store database 342, information of the past winning bid price of the vehicle whose vehicle information substantially matches that of the trade-in vehicle 1a. In a case where there is a plurality of vehicles whose vehicle information substantially matches that of the trade-in vehicle 1a, the winning bid price acquisition unit 333 may acquire an average winning bid price or the highest winning bid price from the information of the winning bid prices of the plurality of vehicles. Note that when the corresponding winning bid price is not stored in the store database 342, the winning bid price of another vehicle that substantially matches regarding specific information (vehicle type or model year) within the vehicle information may be requested. In addition, the winning bid price acquisition unit 333 may request the auction provider terminal 60 via the communication unit 31 for a winning bid price of a vehicle whose vehicle information substantially matches that of the trade-in vehicle 1a, and acquire information of the corresponding winning bid price together with the auction provider ID from the auction provider terminal 60.

The purchase price decision unit 334 decides a purchase price in a case where the second store 2 purchases the trade-in vehicle 1a, which is a shared used car, from the first store 1 on the basis of the trade-in price and the sales price received by the price acquisition unit 331. At that time, the purchase price decision unit 334 decides the purchase price to be a price higher than the above-described winning bid price acquired by the winning bid price acquisition unit 333.

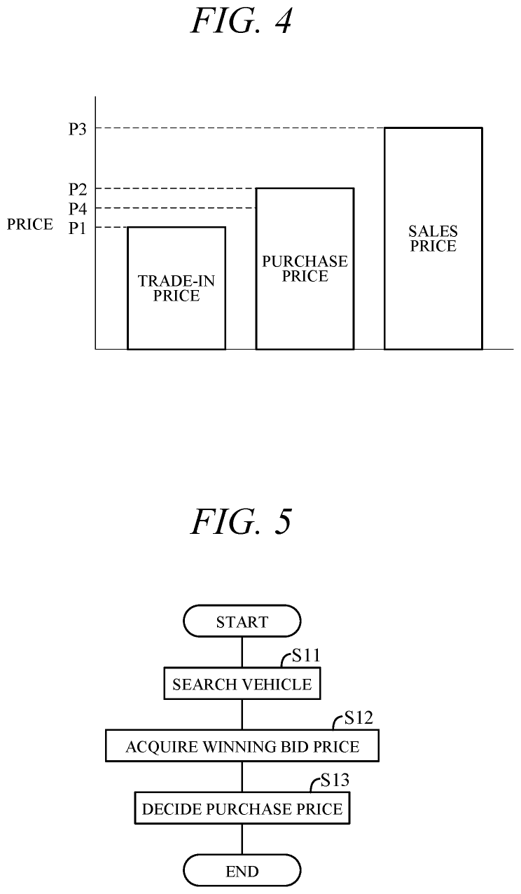

FIG. 4 is a diagram for describing a relationship between trade-in price, purchase price, and sales price. As illustrated in FIG. 4, a purchase price p2 is decided to be a price higher than a trade-in price p1 and lower than a sales price p3. In addition, the purchase price p2 is decided to be a price higher than a winning bid price p4 acquired by the winning bid price acquisition unit 333. The profit obtained by subtracting the purchase price p2 from the sales price p3 corresponds to the profit of the second store 2, and the profit obtained by subtracting the trade-in price p1 from the purchase price p2 corresponds to the profit of the first store 1.

Note that the purchase price decision unit 334 may decide the upper limit value and the lower limit value of the purchase price to give the purchase price a range. By giving the purchase price a range in this manner, for example, the second store 2 can easily adjust the sales price on the basis of the request of the user.

In addition, when the desired sales price acquisition unit 332 acquires the information of the desired sales price of the trade-in vehicle 1a from the second store terminal 20 or the user terminal 40, the purchase price decision unit 334 revises the purchase price on the basis of the desired sales price and decides the purchase price again. At that time, the purchase price is decided again within the range of the upper limit value and the lower limit value.

The purchase price decision unit 334 decides a different revised purchase price between the case where the information of the desired sales price is acquired from the second store terminal 20 and the case where the information of the desired sales price is acquired from the user terminal 40. More specifically, in a case where the purchase price decision unit 334 acquires the information of the desired sales price from the user terminal 40, the revised purchase price lower than the case where the information of the desired sales price is acquired from the second store terminal 20 is decided. Thus, when the information of the desired sales price is acquired from the second store terminal 20, a higher sales price than when the information of the desired sales price is acquired from the user terminal 40 can be presented to the user 4. Therefore, it can be expected that the user 4 visits the second store 2 and negotiates with the clerk of the second store 2 on a price reduction instead of from home, and the number of users using the second store terminal 20 can be increased.

In addition, the purchase price decision unit 334 adjusts the revised purchase price in consideration of a price fluctuation factor that affects the sales price of the trade-in vehicle 1a. Examples of the price fluctuation factor include the ownership period of the trade-in vehicle 1a by the first store 1, the purchase time of the trade-in vehicle 1a by the second automobile store, and the like.

For example, in a case where the ownership period of the trade-in vehicle 1a by the first store 1 is long, the purchase price decision unit 334 can determine that the trade-in vehicle 1a is a vehicle that is difficult to sell, and thus decides a revised purchase price having a relatively large price reduction range.

In addition, for example, the purchase price decision unit 334 decides a revised purchase price having a relatively small price reduction range at a time when the used cars are relatively well sold, such as a bonus time or the end of fiscal year. On the other hand, the purchase price decision unit 334 decides a revised purchase price having a relatively large price reduction range at a time when the used cars are relatively difficult to sell, such as the beginning of fiscal year.

In a case where the sales price of the trade-in vehicle 1a has not been acquired from the first store terminal 10 at the point of time when the purchase price decision unit 334 decides the purchase price of the trade-in vehicle 1a, the sales price decision unit 335 decides the sales price of the trade-in vehicle 1a on the basis of the trade-in price of the trade-in vehicle 1a. Note that, in a case where the sales price decision unit 335 decides the sales price of the trade-in vehicle 1a, the purchase price decision unit 334 decides the purchase price on the basis of the trade-in price acquired by the price acquisition unit 331 and the sales price decided by the sales price decision unit 335.

The price transmission unit 336 transmits the purchase price decided by the purchase price decision unit 334 and the sales price acquired by the price acquisition unit 331 to the second store terminal 20 of the second store 2 via the communication unit 31. Note that when the sales price decision unit 335 decides the sales price of the trade-in vehicle 1a, the price transmission unit 336 transmits the purchase price decided by the purchase price decision unit 334 and the sales price decided by the sales price decision unit 335 to the second store terminal 20 of the second store 2 via the communication unit 31.

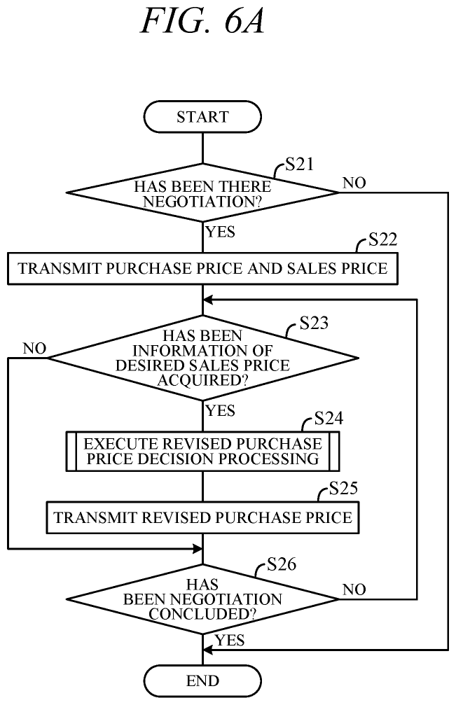

FIG. 5 is a flowchart illustrating an example of purchase price decision processing executed by the server apparatus 30. The processing illustrated in FIG. 5 is started, for example, when the server apparatus 30 acquires the trade-in price of the trade-in vehicle 1a transmitted from the first store terminal 10.

As illustrated in FIG. 5, first, in step S11, a shared used car whose vehicle information substantially matches that of the trade-in vehicle 1a is searched from the store database 342. Next, in step S12, the sales history information of the shared used car searched in step S11 is acquired from the store database 342, and the winning bid price included in the acquired sales history information is further acquired. Finally, in step S13, the purchase price of the trade-in vehicle 1a is decided on the basis of the winning bid price acquired in step S12. At that time, the purchase price of the trade-in vehicle 1a is decided so as to be higher than the winning bid price acquired in step S12. Note that the sales history information acquired in step S12 may not include the winning bid price. For example, this is a case where the shared used car searched in step S11 is not a vehicle sold in an automobile auction. In such a case, the processing may return to step S11 to search for a shared used car again. At that time, only specific information (vehicle type or model year) within the vehicle information may be used as a search condition to search for the shared used car. In addition, in a case where a plurality of shared used cars is searched in step S11, the purchase price of the trade-in vehicle 1a may be decided in step S13 on the basis of the average winning bid price, the highest winning bid price, or the like of the plurality of shared used cars.

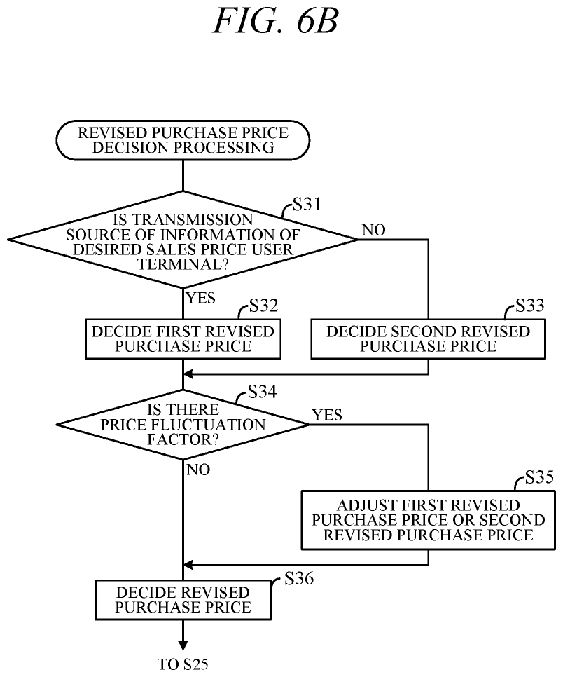

Next, an example of shared used car sales processing executed by the server apparatus 30 will be described. FIG. 6A is a flowchart illustrating an example of shared used car sales processing executed by the server apparatus 30 of FIG. 2. The processing illustrated in FIG. 6A is repeated at a predetermined cycle.

As illustrated in FIG. 6A, first, in step S21, the server apparatus 30 determines whether there has been a negotiation with the user 4 at the second store 2. Specifically, the server apparatus 30 determines that there is a negotiation with the user 4 when receiving a command (transmission request) to transmit the purchase price of the trade-in vehicle 1a from the second store terminal 20 via the communication unit 31. When the determination is affirmative in step S21, the purchase price is transmitted to the second store terminal 20 together with the sales price via the communication unit 31 in step S22. On the other hand, when the determination is negative in step S21, the processing ends. Note that the processing of step S21 may be omitted and may proceed to step S22.

Next, in step S23, it is determined whether or not the information of the desired sales price of the trade-in vehicle 1a has been acquired via the communication unit 31. When the determination is affirmative in step S23, revised purchase price decision processing is executed in step S24. When the determination is negative in step S23, the processing proceeds to step S26.

Here, the revised purchase price decision processing will be described. FIG. 6B is a flowchart illustrating the revised purchase price decision processing. As illustrated in FIG. 6B, first, in step S31, it is determined whether a transmission source of the information of the desired sales price acquired in step S23 is the user terminal 40. When the determination is affirmative in step S31, the purchase price of the trade-in vehicle 1a decided in step S13 of FIG. 5 is decided again on the basis of the acquired information of the desired sales price. The purchase price decided again at this time is referred to as a first revised purchase price. On the other hand, when the determination is negative in step S31, more specifically, when the transmission source of the information of the desired sales price is the second store terminal 20, the purchase price of the trade-in vehicle 1a decided in step S22 is decided again on the basis of the acquired information of the desired sales price. The purchase price decided again at this time is referred to as a second revised purchase price. Note that the second revised purchase price is decided to be a price lower than the first revised purchase price.

Next, in step S34, it is determined whether there is a price fluctuation factor. When the determination is negative in step S34, in step S36, the first revised purchase price decided in step S32 or the second revised purchase price decided in step S33 is decided to be the revised purchase price.

On the other hand, when the determination is affirmative in step S34, in step S35, the first revised purchase price decided in step S32 or the second revised purchase price decided in step S33 is adjusted on the basis of the price fluctuation factor, and the first or second revised purchase price after adjustment is decided to be the revised purchase price. Note that steps S34 to S35 may be executed before steps S31 to S33 instead of after steps S31 to S33.

The description returns to FIG. 6A. Next, in step S25, the revised purchase price of the trade-in vehicle 1a decided in step S24 is transmitted to the second store terminal 20 via the communication unit 31. Next, in step S26, it is determined whether the negotiation has been concluded. Specifically, it is determined whether or not a command for requesting purchase of the trade-in vehicle 1a has been received from the second store terminal 20.

When the determination is affirmative in step S26, the processing ends. On the other hand, when the determination is negative in step S26, the processing returns to step S24, and the processing of steps S23 to S26 is repeated until the negotiation is concluded. At that time, in a case where the negotiation is not concluded even after a lapse of a certain period of time, the processing may be terminated. In addition, in a case where a notification indicating that the negotiation has been canceled is received from the second store terminal 20, the processing may be terminated.

In a case where the negotiation is concluded in the processing of FIG. 6A, the server apparatus 30 transmits, to the logistics provider terminal 50, a signal instructing land transportation of the trade-in vehicle 1a from the first store 1 to the second store 2. When the land transportation of the trade-in vehicle 1a to the second store 2 is completed, the logistics provider 5 transmits a signal indicating the end of the land transportation to the server apparatus 30 via the logistics provider terminal 50. Note that a logistics provider that is a group company of the business entity 3 may be used as the logistics provider 5 in the land transportation of the trade-in vehicle 1a. Thus, it is possible to quickly perform land transportation of the shared used car to the second store 2.

According to the present embodiment, the following functions and effects can be exerted.

(1) The server apparatus 30 manages the trade-in vehicle 1a traded in at the first store 1 and owned by the first store 1 such that the trade-in vehicle 1a can be sold at the second store 2 different from the first store 1. The server apparatus 30 includes the price acquisition unit 331 that acquires the trade-in price and the sales price of the trade-in vehicle 1a, the purchase price decision unit 334 that decides the purchase price when the second store 2 purchases the trade-in vehicle 1a from the first store 1 on the basis of the trade-in price and the sales price acquired by the price acquisition unit 331, and the price transmission unit 336 that transmits the purchase price decided by the purchase price decision unit 334 and the sales price acquired by the price acquisition unit 331 to the second store 2.

With this configuration, the sales area of the trade-in vehicle 1a is expanded to all shops of the first and second stores 1 and 2 that use the trade-in vehicle sales management service, and thus the likelihood that the trade-in vehicle 1a will sell increases. At the same time, the possibility that the trade-in vehicle 1a is owned as a stock for a long period of time at the first store 1 that has purchased the trade-in vehicle 1a is reduced. Therefore, it is possible to actively present an expensive trade-in price to the user at the time of purchasing the vehicle from the user, it is possible to sufficiently increase the user's satisfaction level, and it is possible to improve the trade-in service provided by the first store 1.

In addition, the second store 2 can negotiate with the user 4 without laying in the trade-in vehicle 1a from the first store 1, and therefore, it is not necessary to own the trade-in vehicle 1a as a stock, and the cost required for vehicle sales by the second store 2 can be reduced.

Furthermore, when an automobile manufacturer, the above-described associated company, or the like provides the trade-in vehicle sales management service using the server apparatus 30, the user can use the trade-in vehicle sales management service with a sense of security.

(2) The sales price of the trade-in vehicle 1a is a sales price given to the trade-in vehicle 1a by the first store 1. Thus, when the trade-in vehicle 1a is already on sale at the first store 1, the purchase price of the trade-in vehicle 1a is decided according to the sales price. Therefore, it is possible to decide an appropriate purchase price according to a market sales price.

(3) The sales price decision unit 335 that decides the sales price of the trade-in vehicle 1a on the basis of the trade-in price of the trade-in vehicle 1a acquired by the price acquisition unit 331 is further included, in a case where the sales price of the trade-in vehicle 1a is not acquired by the price acquisition unit 331, the purchase price decision unit 334 decides the purchase price on the basis of the trade-in price acquired by the price acquisition unit 331 and the sales price decided by the sales price decision unit 335, and the price transmission unit 336 transmits the purchase price decided by the purchase price decision unit 334 and the sales price decided by the sales price decision unit 335 to the second store. Thus, it is possible to decide an appropriate purchase price even in a case where a sales price is not given to the trade-in vehicle 1a, such as a case where the trade-in vehicle 1a has not yet been sold at the first store 1.

(4) The purchase price decision unit 334 decides an upper limit value and a lower limit value of the purchase price, and decides the purchase price within a range of the decided upper limit value and lower limit value. Thus, in a case where the second store 2 receives a price reduction request from the user, the purchase price can be adjusted, and a desired sales price can be presented to the user 4.

(5) The desired sales price acquisition unit 332 that acquires the desired sales price of the trade-in vehicle 1a desired by the second store 2 or the user 4 who wants to purchase the trade-in vehicle 1a is further included, the purchase price decision unit 334 decides again the purchase price decided on the basis of the trade-in price and the sales price acquired by the price acquisition unit 331 on the basis of the desired sales price acquired by the desired sales price acquisition unit 332, and the price transmission unit 336 transmits the purchase price decided again by the purchase price decision unit 334 to the second store 2. As a result, for example, it is possible to flexibly cope with price reduction negotiation from the user 4 or the second store 2.

(6) The purchase price decision unit 334 adjusts the purchase price decided on the basis of the trade-in price and the sales price acquired by the price acquisition unit 331 on the basis of the desired sales price acquired by the desired sales price acquisition unit 332 and a price fluctuation factor that affects the sales price of the trade-in vehicle 1a. Thus, for example, the purchase price can be decided on the basis of objective information, and the satisfaction of the purchase price can be improved. The satisfaction referred to herein includes the possibility that the purchase price can be accepted.

(7) The price fluctuation factor includes at least one of the ownership period of the trade-in vehicle 1a by the first store 1 and the purchase time of the trade-in vehicle 1a by the second store 2. Thus, in a case where the trade-in vehicle 1a is a vehicle that is difficult to sell or is a long-term stock in the first store 1, the second store 2 can purchase the trade-in vehicle 1a at a purchase price having a relatively large price reduction range, and thus, the trade-in vehicle 1a can be easily sold even in such a case.

In addition, for example, in a case where the second store 2 purchases the trade-in vehicle 1a from the first store 1 at a time when the used cars are relatively sold, such as a bonus time or the end of fiscal year, the trade-in vehicle 1a can be sold even when a revised purchase price having a relatively small price reduction range is decided. On the other hand, a revised purchase price having a relatively large price reduction range is decided at a time when the used cars are relatively difficult to sell, such as the beginning of fiscal year, and the trade-in vehicle 1a can be easily sold. That is, an appropriate purchase price can be decided according to the purchase time of the trade-in vehicle 1a.

(8) The winning bid price acquisition unit 333 that acquires the winning bid price when a vehicle of the same vehicle type as the trade-in vehicle 1a has been auctioned in an automobile auction in the past is further included, the purchase price decision unit 334 decides the purchase price on the basis of the trade-in price and the sales price acquired by the price acquisition unit 331 and the winning bid price acquired by the winning bid price acquisition unit 333. Thus, since the purchase price is decided in consideration of the winning bid price of the same vehicle type as the trade-in vehicle 1a, a more appropriate purchase price can be decided.

(9) The purchase price decision unit 334 decides the purchase price so that the purchase price is a price higher than the trade-in price acquired by the price acquisition unit 331 and the winning bid price acquired by the winning bid price acquisition unit 333 and a price lower than the sales price acquired by the price acquisition unit 331. Since the trade-in vehicle 1a is purchased at a price higher than that for putting up for an automobile auction, the first store 1 is motivated to have the trade-in vehicle 1a as a shared used car. As a result, more trade-in vehicles can be shared used cars.

(10) The vehicle sales management system 100 includes the server apparatus 30, the first store terminal 10 that the first store 1 has and is capable of communicating with the server apparatus 30, and the second store terminal 20 that the second store 2 has and is capable of communicating with the server apparatus 30. On the basis of the transmission request from the second store terminal 20, the server apparatus 30 transmits, to the second store terminal 20, the purchase price at the time when the second store 2 purchases, from the first store 1, the trade-in vehicle 1a purchased by the first store 1 and owned by the first store 1, and the sales price of the trade-in vehicle 1a.

With this configuration, the sales area of the trade-in vehicle 1a is expanded to all shops of the first and second stores 1 and 2 that use the trade-in vehicle sales management service, and the likelihood that the trade-in vehicle 1a will sell increases. At the same time, the possibility that the trade-in vehicle 1a is owned as a stock for a long period of time at the first store 1 that has purchased the trade-in vehicle 1a is reduced.

(11) The server apparatus 30 of the present embodiment can also be used as a vehicle sales management method. The vehicle sales management method manages the trade-in vehicle 1a that has been traded in at the first store 1 and is to be sold or on sale by the first store 1 so as to be able to be sold as a shared used car by a plurality of second stores 2. The price acquisition unit 331 receives an input of the trade-in price of the trade-in vehicle 1a by the first store 1, the purchase price decision unit 334 decides the purchase price in a case where the second store 2 purchases the trade-in vehicle 1a from the first store 1 on the basis of the trade-in price and the sales price of the shared used car received by the price acquisition unit 331, and the communication unit 31 transmits the purchase price and the sales price to the second store 2 on the basis of the transmission request from the second store 2.

With this configuration, the sales area of the trade-in vehicle 1a is expanded to all shops of the first and second stores 1 and 2 that use the trade-in vehicle sales management service, and the likelihood that the trade-in vehicle 1a will sell increases. At the same time, the possibility that the trade-in vehicle 1a is owned as a stock for a long period of time at the first store 1 that has purchased the trade-in vehicle 1a is reduced.

In the above embodiment, the vehicle sales management system 100 includes the first store terminal 10, the second store terminal 20, the server apparatus 30, the user terminal 40, the logistics provider terminal 50, and the auction provider terminal 60, but the present invention is not limited thereto. It is sufficient if the vehicle sales management system includes the first store terminal 10, the second store terminal 20, and the server apparatus 30.

In addition, in the present embodiment, the price acquisition unit 331 of the server apparatus 30 receives the trade-in price and the sales price of the trade-in vehicle 1a input by the first store 1, but the present invention is not limited thereto. For example, the trade-in price may be received by the price acquisition unit 331, and the sales price of the shared used car may be decided by the sales price decision unit 335. That is, the server apparatus 30 may be configured to decide the purchase price and the sales price.

Furthermore, in the above embodiment, the winning bid price acquisition unit 333 acquires the information of the past winning bid price of the vehicle whose vehicle information substantially matches that of the trade-in vehicle 1a from the store database 342, but the configuration of the winning bid price acquisition unit 333 is not limited to the above as long as the information of the winning bid price can be acquired. In a case where the information of the winning bid price of the vehicle whose vehicle information substantially matches that of the trade-in vehicle 1a is not stored in the store database 342, the winning bid price acquisition unit may acquire the sales price of the vehicle whose vehicle information substantially matches that of the trade-in vehicle 1a from the store database 342. In addition, the winning bid price acquisition unit may calculate an assumed winning bid price in a case where the trade-in vehicle 1a is put up for an automobile auction on the basis of the sales price. In that case, the purchase price decision unit may decide the purchase price to be a price higher than the assumed winning bid price calculated by the winning bid price acquisition unit.

1-11. (canceled)

12. A vehicle sales management apparatus managing a trade-in vehicle traded in at a first store and owned by the first store such that the trade-in vehicle can be sold at a second store different from the first store, the vehicle sales management apparatus comprising:
a CPU and a memory, wherein
the CPU is configured to perform
acquiring a trade-in price and a sales price of the trade-in vehicle;
deciding a purchase price when the second store purchases the trade-in vehicle from the first store on the basis of the trade-in price and the sales price acquired in the acquiring; and
transmitting the purchase price decided in the deciding and the sales price acquired in the acquiring to the second store.

13. The vehicle sales management apparatus according to claim 12, wherein
the sales price of the trade-in vehicle is a sales price given to the trade-in vehicle by the first store.

14. The vehicle sales management apparatus according to claim 12, wherein
the CPU is configured to further perform
deciding a sales price of the trade-in vehicle on the basis of the trade-in price of the trade-in vehicle acquired in the acquiring, wherein
the CPU is configured to perform
the deciding the purchase price including, in a case where the sales price of the trade-in vehicle is not acquired in the acquiring, deciding the purchase price on the basis of the trade-in price acquired in the acquiring and the sales price decided in the deciding the sales price, and
the transmitting includes transmitting the purchase price decided in the deciding the purchase price and the sales price decided in the deciding the sales price to the second store.

15. The vehicle sales management apparatus according to claim 12, wherein
the CPU is configured to perform
the deciding including deciding an upper limit value and a lower limit value of the purchase price, and decides the purchase price within a range of the upper limit value and lower limit value.

16. The vehicle sales management apparatus according to claim 12, wherein
the CPU is configured to further perform
acquiring a desired sales price of the trade-in vehicle desired by the second store or a user who wants to purchase the trade-in vehicle, wherein
the CPU is configured to perform
the deciding including deciding again the purchase price decided on the basis of the trade-in price and the sales price acquired in the acquiring the trade-in price and the sales price, on the basis of the desired sales price acquired in the acquiring the desired sales price, and
the transmitting includes transmitting the purchase price decided again in the deciding to the second store.

17. The vehicle sales management apparatus according to claim 12, wherein,
the CPU is configured to perform
the deciding including adjusting the purchase price decided on the basis of the trade-in price and the sales price acquired in the acquiring, on the basis of a price fluctuation factor affecting the sales price of the trade-in vehicle.

18. The vehicle sales management apparatus according to claim 17, wherein,
the price fluctuation factor includes at least one of an ownership period of the trade-in vehicle by the first store and a purchase time of the trade-in vehicle by the second store.

19. The vehicle sales management apparatus according to claim 12, wherein
the CPU is configured to further perform
acquiring a winning bid price when a vehicle of a same vehicle type as the trade-in vehicle has been previously auctioned in an automobile auction, wherein
the CPU is configured to perform
the deciding including deciding the purchase price on the basis of the trade-in price and the sales price acquired in the acquiring the trade-in price and the sales price and the winning bid price in the acquiring the winning bid price.

20. The vehicle sales management apparatus according to claim 19, wherein
the CPU is configured to perform
the deciding including deciding the purchase price so that the purchase price is a price higher than the trade-in price acquired in the acquiring the trade-in price and the sales price and the winning bid price acquired in the acquiring the winning bid price and so that the purchase price is a price lower than the sales price acquired in the acquiring the trade-in price and the sales price.

21. The vehicle sales management apparatus according to claim 19, wherein
the CPU is configured to perform
the acquiring the winning bid price including acquiring a sales price of the vehicle of the same vehicle type when it is possible not to acquire the winning bid price of the vehicle of the same vehicle type and calculating an assumed winning bid price in a case where the trade-in vehicle is put up for the automobile auction on the basis of the sales price of the vehicle of the same vehicle type, and
the deciding including deciding the purchase price on the basis of the trade-in price and the sales price acquired in the acquiring the trade-in price and the sales price and the assumed winning bid price.

22. A vehicle sales management system comprising;
the vehicle sales management apparatus according to claims 12:
a first store terminal managed by the first store and capable of communicating with the vehicle sales management apparatus: and
a second store terminal managed by the second store and capable of communicating with the vehicle sales management apparatus, wherein
the CPU is configured to perform
the transmitting including, on the basis of the transmission request from the second store terminal, transmitting, to the second store terminal, the purchase price at a time when the second store purchases, from the first store, the trade-in vehicle purchased and owned by the first store, and the sales price of the trade-in vehicle.

23. A vehicle sales management method managing a trade-in vehicle traded in at a first store and owned by the first store such that the trade-in vehicle can be sold at a second store different from the first store, the vehicle sales management method comprising:
acquiring a trade-in price and a sales price of the trade-in vehicle;
deciding a purchase price when the second store purchases the trade-in vehicle from the first store on the basis of the trade-in price and the sales price acquired in the acquiring; and
transmitting the purchase price decided in the deciding and the sales price acquired in the acquiring to the second store.
